(19) United States
(12) Patent Application Publication
(10) Pub. No.: US 2006/0247050 A1
(43) Pub. Date: Nov. 2, 2006

(54) Method and apparatus for gaming machine architectures, communications, and other improvements

(76) Inventor: Richard Mathis, Las Vegas, NV (US)

Correspondence Address: REED SMITH, LLP, TWO EMBARCADERO CENTER, SUITE 2000, SAN FRANCISCO, CA, 94111, US

(21) Appl. No.: 11/399,748

(22) Filed: Apr. 7, 2006

Related U.S. Application Data
(60) Provisional application No. 60/669,270, filed on Apr. 7, 2005.
(60) Provisional application No. 60/729,650, filed on Oct. 24, 2005.

(51) Int. Cl. A63F 13/00

(52) U.S. Cl. 463/39; 463/20

(57) ABSTRACT

A gaming machine with serial communications between components of the gaming machine and a controller. A power bus distributes power to the componetns attached via quick connects. High Frequesncy (HF) communications are transmitted over the power bus or in Radio Frequency (RF) wireless transmissions. The gaming machine enclosure prevents RF leakage, prohibits injection of unauthorized communications, and serves as a ground. The components may be physically and electrically secured in the enclosure via magnets. Game outcome decisions are exclusively decided by the controller. User inputs are provided to the gaming machine from a remote device, such as user I/O devices that fold out from a comfortable chair or other location convenient to game players.

### CROSS REFERENCE TO RELATED APPLICATIONS AND CLAIM OF PRIORITY

This invention claims priority to the following co-pending U.S. provisional patent applications, which are incorporated herein by reference, in its entirety:

Mathis, U.S. Provisional Patent Application Ser. No. 60/669,270, filed Apr. 7, 2005, and Mathis, U.S. Provisional Patent Application Ser. No. 60/729,650 filed Oct. 21, 2005.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to gaming machine architectures.

2. Discussion of Background

Gaming machines are beginning to incorporate new features based upon video displays and sometimes require control from a central location. Game controllers based upon personal computer architecture primarily to allow complexities of driving a video display and use of common networking techniques are replacing traditional microcontroller architecture. Common personal computer operating systems such as Windows and Linux are being employed to allow rapid development of gaming machines.

Traditional gaming machines whose control is based upon a microcontroller are reasonably secure from being cheated and gaming regulatory agencies in various jurisdictions have developed means for reliably checking microcontroller program memory. The agencies have devoted time and resources in developing methods of checking microcontroller program memory and training personnel to be proficient at doing so. Personal computer operating systems typically require much more program memory than that required for a microcontroller based system and, additionally, personal controller operating systems continually write to mass storage unless special methods are employed. If mass storage, such as a hard disk drive, is written, normal signature verification methods of determining that program memory has not been altered become extremely difficult. Since the majority of jurisdictional checks of program memory of microcontroller based machines are based upon some sort of memory signature verification technique, costly new techniques must be developed, new equipment purchased and new training procedures implemented for employees. Even then it is difficult to assure that program memory has not been altered when program memory is implemented in mass storage that can be altered by the operating system of the game controller.

Many improvements have been made to gaming machines, but very little has been done to address the component interconnection and power provisions of modern electronic gaming machines. The majority of gaming machines still consist of a set of control components connected together by wire harnesses and are relatively inflexible in providing provisions for expansion of functionality. Even newer serial bus architecture is relatively inflexible in providing mounting locations for new components as they are required and in order to provide mounting space for said new components a major re-design of a game enclosure must generally be done. Re-design of a power wire harnesses and data communication harnesses generally must also be done in order to accommodate new or expanded functionality.

Finally, it has been determined in numerous studies that player enjoyment is enhanced by comfortable and ergonomic user interaction with a gaming apparatus.

### SUMMARY OF THE INVENTION

The present inventor has realized the need for flexible control component interconnect, component mounting, and communication between elements of a gaming machine. The present inventor has also realized the need for an electronic gaming machine architecture that allows verification of program memory by means of a signature as it has been traditionally accomplished, that is easily expandable to accommodate new peripherals, allows a video interface upon which high resolution video games can be played and is economical to manufacture. An electronic gaming machine architecture that meets aforesaid criteria is described in the present invention. The present invention is embodied, for example, in architectures, systems, and devices directed toward implementing these needs.

The present invention includes devices for component mounting, data communication and power distribution that is flexible and does not require re-design of a gaming machine enclosure in order to re-position control components or to add new control components. Components are located within a gaming machine in manner that is cost effective and less time consuming.

In one embodiment, the present invention provides a gaming machine, comprising, a gaming machine enclosure, a series of gaming components operable together to enable the gaming machine to play a game, wherein a least two of the gaming machine components communicate with each other via High Frequency (HF) communications. The gaming machine, for example, accepts wagers and plays a game of chance. In one alternative, the gaming machine plays a skill game whose outcome is substantially determined by a player's skill.

In one embodiment, the gaming machine comprises a power bus configured to distribute a power lead to the gaming components via quick connectors, and a gaming machine enclosure comprises a return power ground for the gaming components. In one embodiment, all memory subject to gaming regulation checking is concentrated on the main game controller.

In another embodiment, the present invention provides a gaming machine, comprising, a gaming machine enclosure, a series of gaming components operable together to enable the gaming machine to play a game, and a main processing board comprising a game machine control processor and memory for storing programming for the game machine control processor comprising at least one game to be played by the gaming machine, wherein all game determining decsisions are determined by the control processor, and the game determining decisions (control processor) and other gaming components of the gaming machine are separated from the main board by at least a serial interface.

In another embodiment, the present invention provides a gaming machine device, comprising, a gaming machine enclosure comprising a user interface including a display for showing results of a game played on the gaming machine and user input devices on the enclosure and accessible to a gaming machine user, a second user interface device separate and apart from the gaming machine and gaming machine enclosure and a wireless communication mechanism that transmits user inputs from the second user interface, and a wireless receiver coupled to the gaming machine and configured to receive user inputs transmitted from the second user interface, wherein the gaming machine is operable from the user input devices on the enclosure and/or the second user interface device.

The present invention provides a system that allows placement of components in nearly any desired location within a gaming machine enclosure may be comprised of a well-isolated direct current bulk power supply from which the most positive supply lead is connected to a system of quick-connect power buses and from which the negative or reference lead of said bulk power supply is connected to a point on said enclosure or to another set of quick-connect power buses. Said quick-connect power buses are separated from the enclosure by electrically nonconducting material. It is important that the enclosure be a good conductor of both electromagnetic energy and electrostatic energy. Most modern gaming machine enclosures are constructed of cold-rolled steel sheet, which is an excellent conductor of electromagnetic and electrostatic energy. Cold-rolled steel sheet also exhibits ferromagnetic properties. Components of a gaming machine may be subdivided into categories that allow major functions to be grouped into a single location and enclosed in a separate enclosure within the gaming machine enclosure. Each of said components may include a point of load power converter that attaches anywhere convenient on a quick connect power bus and which converts power provided by the bulk power supply into electrical power of a voltage suitable to power a control component. A control component may be mounted to the gaming machine enclosure by means of an electrically conductive magnet or by means of electrically conductive adhesive or by means of an electrically non-conductive adhesive. If an electrically non-conductive adhesive is used to mount a control component a provision must be made to allow electrical connection to the reference potential of the bulk power supply. Said attachment is simple since the entire enclosure will be at electrical reference potential. Any component may be attached to the inside of the gaming machine enclosure at any point in the system of the present invention. Communication between components may be by means of low power radio frequency. Any communication scheme that is used in a gaming machine designed for distributed components and a serial bus may be used. Such a system is described in U.S. Provisional Patent Application 60/669,270.

A typical gaming apparatus presents a set of user controls arranged in a fixed configuration on the front cabinet housing of said apparatus. Said fixed configuration of controls in most cases does not allow for any flexibility in conforming to player preference and, in fact, requires that a player conform to the apparatus controls in order to play a game. The present inventor has realized a need for a method to enhance player comfort when playing a gaming apparatus which is affordable to an operator of gaming machines and which is portable between gaming machines. The aforesaid goals may be met by designing a generic interface that may be retrofitted into existing gaming apparatus and which may also be built into newly manufactured apparatus. A portable player set of controls may be provided by means of an interface compatible with aforesaid gaming machine interface that is built into a chair which is provided for player comfort when playing a gaming machine.

Portions of both the device and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of the present invention installed in an enclosure of a gaming apparatus.

FIG. 2 is a perspective view of a quick-connect power bus and bus connector.

FIG. 3 is a back view of a sheet metal enclosure used to house a set of control components and showing a mounting method according to the present invention.

FIG. 4 is a block diagram showing a first method of communicating between command and control modules according to the present invention.

FIG. 5 is a block diagram showing a second method of communicating between command and control modules according to the present invention.

FIG. 6 is a block diagram representation of a local network of components comprising a gaming machine of the present invention.

FIG. 7 is a block diagram representation of a door controller module that may be included in a gaming machine of the present invention.

FIG. 8 is a block diagram representation of a game controller module that may be included in a gaming machine of the present invention.

FIG. 9 is a block diagram representation of a reel controller module that may be included in a gaming machine of the present invention.

FIG. 10 is a flow chart representation of a security poll program that may run on a microcontroller in a game controller module that may be included in a gaming machine of the present invention.

FIG. 11 is a flow chart representation of a main program that may run on a microcontroller in a game controller module that may be included in a gaming machine of the present invention.

FIG. 12 is a representation of data that may be included in a machine state table that may be included in a gaming machine of the present invention.

FIG. 13 is a representation of data that may be included in a machine state table of a PC based peripheral that may be included in a gaming machine of the present invention.

FIG. 14 is a drawing illustrating salient elements of the present invention.

FIG. 15 is a block diagram representation of an electronic interface that may be installed in a player chair.

FIG. 16 is a block diagram representation of an electronic interface that may be installed in a gaming apparatus.

### DESCRIPTION OF THE PREFERRED EMBODIMENTS

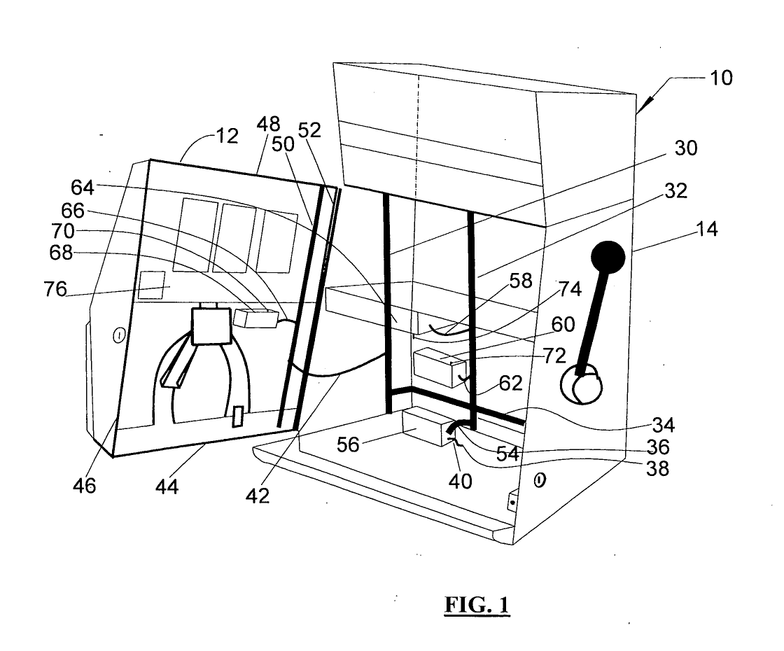

Referring now to the drawings, wherein like reference numerals designate identical or corresponding parts, and more particularly to FIG. 1 thereof, there is illustrated a perspective view of a gaming machine enclosure 14 with game control components mounted according to an embodiment of the present invention. Components may be divided into groups that allow commonality of connection to main control points or may be divided into groups that allow commonality of control function. Components that allow operation of gaming machine 10 may be a main game controller 64, a door and player switch monitoring unit 68, a payout monitoring and control unit 62 and other various control and monitoring units as may be deemed desirable, but may be added in the future. A bulk double-insulated power supply 56 is supplied from mains voltage and generates a bulk direct current (d.c.) voltage to supply all control components that may be connected within the enclosure 14. A ground reference of said power supply may be connected to the enclosure at connection point 38 by means of electrical conductor 40; positive bulk voltage may be distributed within the enclosure by means of electrical conductor 36 to a bus structure, comprised of buses 30, 32, 34 and 50. Flexible electrical conductor 42 connects quick-connect bus 50 in machine enclosure door 12 to the positive bus structure within the fixed portion of the enclosure assuring that bulk voltage is available to all components. Electrical grounding strips are placed around the door at 44, 46, 48 and 52. Purpose of said grounding strips is to prevent leakage of radio frequency (rf) energy outside of the enclosure. Leakage of rf energy through sections of the door that are covered by glass may be by means of using a glass that is lossy to rf or by means of a rf lossy transparent plastic film placed over said sections 76. Main game controller 200 may be connected to quick-connect power bus 32 by means of electrical conductor 58, door function monitor and control component 206 may be connected to quick-connect power bus 50 by means of electrical conductor 66 and payout monitor and control component 202 may be connected to quick connect power bus 32 by means of electrical conductor 62. Said main game controller may communicate with all other components by means of a radio frequency transceiver, antenna of which is shown at 74; control component 206 may communicate with all other components by means of a radio frequency transceiver, antenna of which is shown at 70 and control component 202 may communicate with all other components by means of a radio frequency transceiver, antenna of which is shown at 72. Quick connect power buses may be interconnected by means of electrical conductors 34 and 42 to assure that sufficient unused quick connect power bus capacity remains for attachment of additional components in future modifications to the gaming machine.

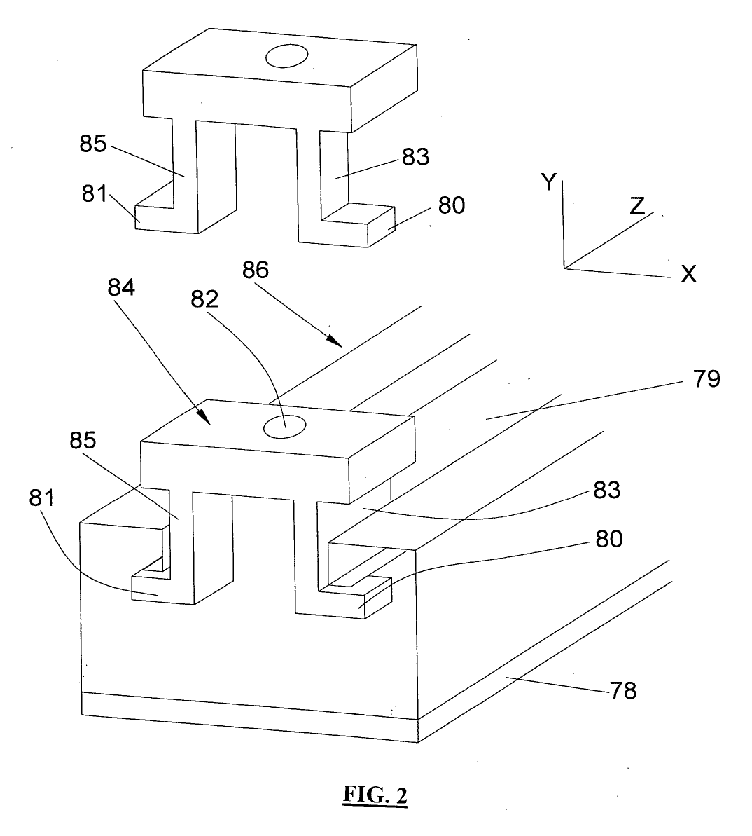

FIG. 2 shows a perspective view of a quick-connect power bus 86 according to an embodiment of the present invention. Said power bus may consist of an electrically conducting extrusion as depicted in the drawing. The power bus is separated from the enclosure 14 of gaming machine 10 shown in FIG. 1 by an electrically non-conducting strip 78 and may be fastened to the gaming machine enclosure by means of electrically non-conducting adhesive or electrically non-conducting fasteners. A quick-connector 84 may be constructed of an electrically conducting spring material and may be fastened to an electrical conductor by means of a fastener at 82. Said quick-connector is turned 90 degrees about the y axis from the position shown in FIG. 2, inserted into the opening 79 in the track of the quick-connect bus and then turned 90 degrees in either direction about the y axis to lock the quick connector into place. Protrusions 80 and 81 on the quick-connector and spring tension exerted by legs 85 and 88 prevent removal from the quick-connect bus unless the quick-connector is turned 90 degrees about the y axis.

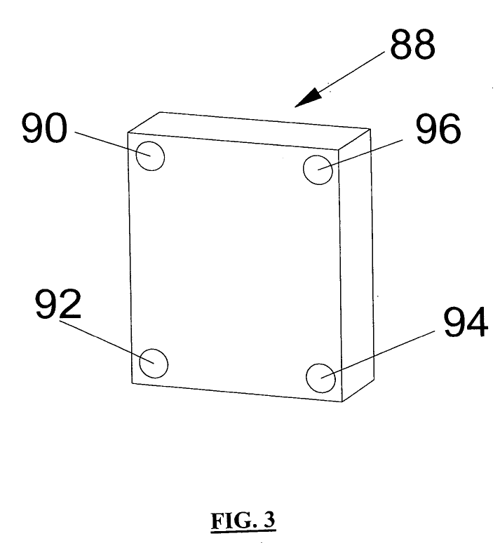

FIG. 3 is a perspective back view of an enclosure 88 that may be used to house control and monitoring components as in 200, 202 and 206. Mounting of said enclosure to gaming machine enclosure 14 may be by means of electrically conductive magnets 90, 92, 94 and 96. Said magnets may be fixed to the enclosure by means of adhesive. The enclosure is preferably constructed of a ferromagnetic material since said material provides electromagnetic shielding for components inside the enclosure. The magnets allow a quick positioning and mounting of components inside the gaming machine enclosure and provide the electrical reference or ground connection for the bulk power supply that supplies point of load converters on each component. If the game machine enclosure 14 is constructed of a ferromagnetic material the walls of the enclosure provide a magnetic short circuit, which prevents magnetic fields from being induced outside the enclosure.

Monitor and control components may be in electrical data communication with each other to accomplish desired operation of the gaming machine. One method of providing communication between all monitor and control components is by means of a high frequency radio transceiver. Modern solid state radio transceivers that operate in the frequency range of 2.4 GHz and above are easily obtained and will be more cost effective than data cables and connectors presently used to provide data communication within gaming machines. Additionally the data communicated between modules may be automatically encrypted to very high standards providing excellent security to a gaming machine operation. Employing a high frequency low-power transceiver also allows data communication to be restricted to the interior of the gaming machine enclosure. Any firmware or data communication scheme developed for a gaming machine including a serial bus is easily converted to a data communication scheme that employs a high frequency radio frequency transceiver.

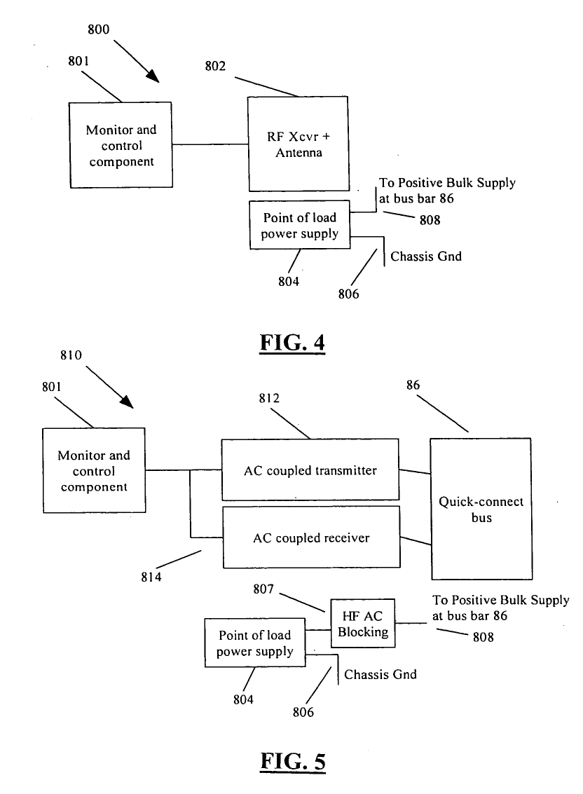

Turning now to FIG. 4, 801 may be any monitor and control component used in a gaming machine, several block diagram examples elements included within monitor and control components are illustrated in U.S. Provisional Patent Application 60/669,270, communication between all other monitor and control components are provided by 802 which may be a low-power, high frequency radio transceiver. A point of load power supply 804 is provided at each monitor and control component and is electrically connected to positive electrical potential on the quick-connect bus at 808 and to reference electrical potential at 806. Connection to reference electrical potential may be provided by connecting to the gaming machine enclosure if good electrical conducting connection is available or may be provided by a separate quick-connect bus system that provides bulk power supply reference potential.

Another method of providing data communication between monitor and control components is illustrated in block diagram form in FIG. 5 in which high frequency data communication may be provided between all components connected to the quick-connect bus simultaneously with the bus providing direct current electrical power. An A.C. coupled transmitter is provided at 812. Said transmitter may be comprised of an amplifier connected to the quick connect bus 86 by means of a capacitor or by means of a band pass filter; passband frequency of said band pass filter must include the principal frequency of data transmission. An A.C. coupled receiver is provided at 814 and may be comprised of an amplifier connected to the quick-connect bus by means of a capacitor or band pass filter. Point of load power supply 804 is connected to the quick-connect bus by means of an A.C. blocking network 807 which may be a large value inductor. Connection of bulk power supply 56 to the quick-connect bus at 36 includes means of A.C. blocking. Data communication is encoded by means of a well-known Manchester algorithm to provide D.C. balance and occurs in a half-duplex fashion. Data communication between monitor and control components may be accomplished in a master slave polled mode, by means of a token ring scheme or by means of several well-known collision avoidance algorithms.

In one embodiment, a gaming machine of the present invention comprises a plurality of electronic peripheral modules that communicate with each other and with a game controller module by means of a serial communication algorithm utilizing a physical layer that supports electronic or optical serial communication of messages. Each peripheral module can initiate a message and can receive messages. All peripheral modules are in communication with a game controller module. Said game controller module controls and makes all decisions concerning game outcome, wager and payout. Even though each peripheral module is capable of independent action and allowed a degree of autonomy as specified by a program running on each peripheral module, primary control of all interconnected modules is by means of a program running on a microcontroller on said game controller module. Since all actions affecting game outcome are performed by a microcontroller on the game controller module, program memory for said microcontroller concentrates all memory that must be checked for integrity by gaming enforcement authorities. Said program memory is generally not large and can be stored in a memory device that allows memory verification by existing techniques with which all gaming enforcement personnel are familiar.

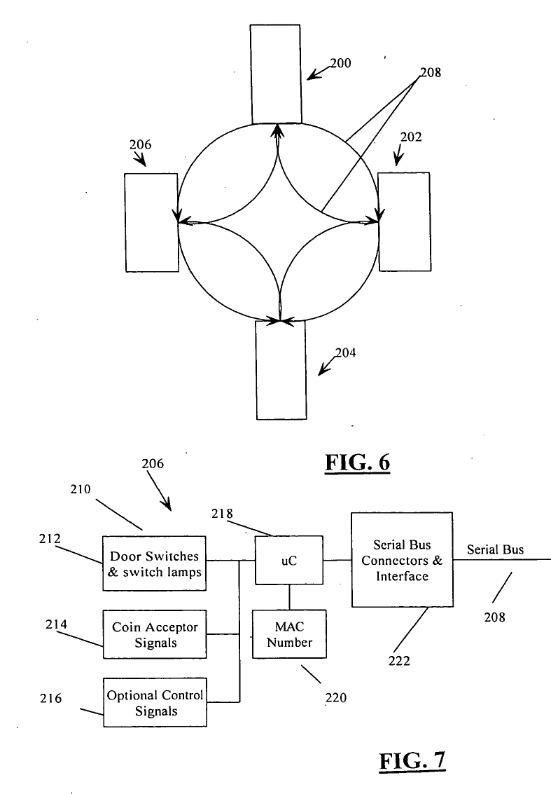

Turning now to FIG. 6 which is a block diagram representation of a local network of components comprising a gaming machine of the present invention, 200 represents a game controller module that communicates with all modules connected to local network 208. As previously described, said game controller module controls any parameter that affects game outcome or pay. Block 206 represents a door control module connected to local network 208. Said door control module monitors all switch inputs located on a front panel or door of a gaming machine and communicates the state of all inputs to the game controller module for appropriate action. The door control module may also communicate directly, using a limited command set, with any other module attached to the local network. Block 204 represents a reel control module connected to local network 208. Said reel control module receives reel position and reel velocity instructions from the game controller and updates reel position accordingly. In a traditional stepper reel type gaming machine there is typically a plurality of said reel control modules. The reel control module also sends reel position information and velocity information to the game controller. A reel control module may also communicate directly, using a limited command set, with any other module attached to the local network. Block 202 represents a video controller. Said video controller may be an embedded PC with mass storage consisting of any type of memory storage commonly available. The video controller may be operating under any operating system and preferably will be operating under a commonly available operating system that supports programs for displaying high definition animated video. The video controller may gather information from a touch screen overlaying a video display or monitor and send said information back to the game controller. Typically a touch screen is configured to show images of buttons or icons used for play or wager and tables that allow game play and payout information to a player of a game. Information from said touch screen is transmitted by electronic means from the video controller to the game controller module and any information that affects game outcome or pay is processed on the game controller module and sent to the appropriate peripheral device connected to the local network 208. The video controller makes no decisions that affect game outcome or pay to a player of a game.

Turning now to FIG. 7 which is a block diagram representation of a door controller module 206 that may be included in a gaming machine of the present invention, 218 is a microcontroller that gathers information from inputs on a player panel or door panel of a gaming machine and controls lights and other player information devices on said door panel. Some examples of devices controlled by said door controller module may be lighted switches and game play switches 210, coin acceptor signals originating at coin accepting devices that verify coins wagered upon a game 214, and other control signals that may be required for various games and player attraction 216. A unique network identification number 220 is associated with each door module. Said network identification number is used to identify a module connected to the local network 208 and may serve to identify a source and destination for information received and sent by the game controller 200. The door controller module connects to local network 208 by means of network compatible connectors and interface components 222.

Turning now to FIG. 9 which is a block diagram representation of a reel controller module for a reel-type player interface, 250 is a microcontroller that receives reel position and velocity information from the game controller over the local network. Reel motor driver 252 controls reel motor 254 to which a reel or disk is attached to form a visual display and indicator for a player of a game including said reel controller module. Said reel motor driver receives motor and velocity commands from microcontroller 250. A unique network identification number 220B is associated with each reel controller module. Said network identification number is used to identify a module connected to the local network 208 and may serve to identify a source and destination for information received and sent by the game controller 200. The reel controller module connects to local network 208 by means of network compatible connectors and interface components 222A.

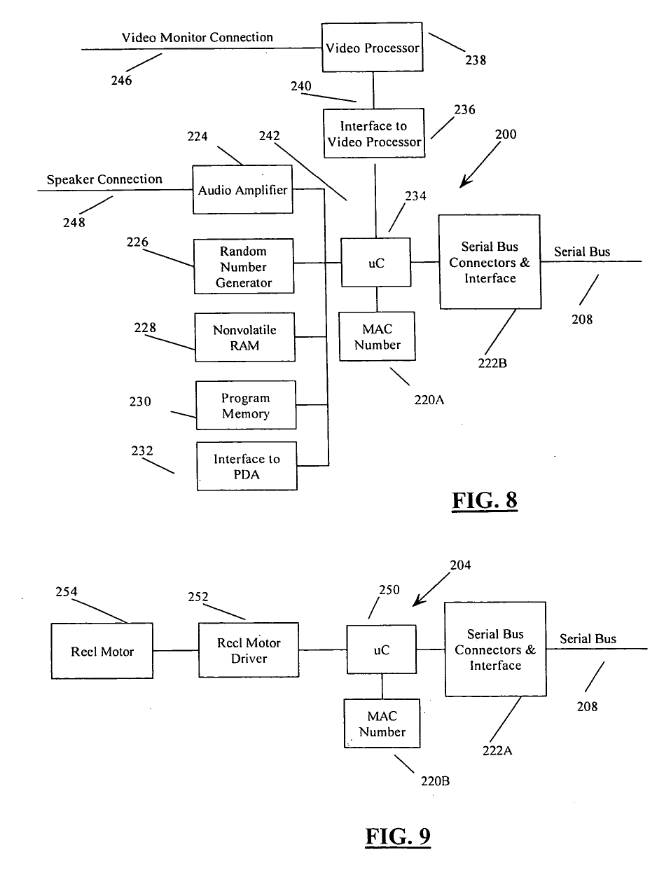

Turning now to FIG. 8 which is a block diagram representation of a game controller module of the present invention, 234 is a microcontroller or microprocessor that runs a program stored program memory 230 that typically may be of EPROM or non-writable Flash technology. Said program memory may be connected to 234 through a memory protection device 231 that is described in U.S. patent application Ser. No. 09/827,008 and which allows remote reading and online checking of program memory signature. Nonvolatile RAM (random access memory) 228 is provided for storage of game state at any time should power outage occur. A random number generator 226 is provided to allow microcontroller 234 to generate various game and pay parameters as required by individual games. All random numbers required in determining game outcome and/or player pay must be drawn from 226 and transmitted to a module requesting them. No random numbers that determine game outcome and/or player pay may be used on any module included in the present invention that have not been generated in 226. Audio amplifier 224 may be used to drive speakers directly, if required, from the game controller module through speaker connection 248. Driving of speakers directly from the game controller module allows cost reduction if no video processor is required in a gaming machine. An interface to a personal digital assistant (PDA) 232 is provided to allow game configuration in jurisdictions where it is permitted and also to allow a quick method of reading machine parameters and performance. An interface 236 to video processor 238 allows commands to be transmitted to said video processor by the game controller and allows video game status to be received by the game controller. Any information required by the video processor that affects game outcome or pay to a player must be requested from the game controller and the game controller must respond with the requested information before play can continue on the video processor. The video processor connects to graphic player displays by means of video monitor connection 246. A power controller 235 may be controlled by the game controller and may be used to interrupt electrical power to the video processor upon predetermined conditions occurring. Interrupting power to the video processor can be used to disable the video processor in the case of the video processor not transmitting predetermined information requested by the game controller. A unique network identification number 220A is associated with each game controller module. Said network identification number is used to identify information received and sent by the game controller. The game controller module connects to local network 208 by means of network compatible connectors and interface components 222B.

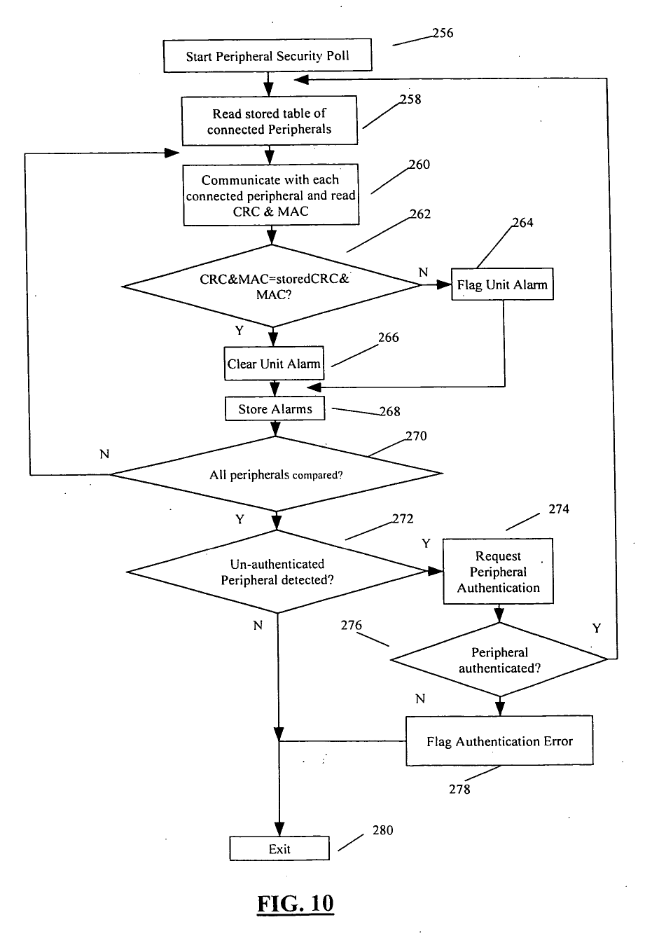

Turning now to FIG. 10 which is a flow chart representation of a security poll program that may run on a microcontroller in a game controller module that may be included in a gaming machine of the present invention, said security poll program begins at 256 where initialization of registers is performed and continues to 258 where a previously stored table of peripherals that are authenticated and known to be connected to local network 208 is read into memory for comparison. Program continues to 260 where communication is established with a peripheral on the local network 208 in order to read a unique electronic identification number (MAC) and memory signature (CRC) representing identification of program running on said peripheral. Program continues to 266 where said MAC and CRC read are compared to corresponding values in said previously stored table of peripherals read in 258. If corresponding values do not compare, the program continues to 264 where an error flag is set and then continues to 268. If corresponding values do compare the program continues to 266 where any error flag due to non-comparison of said values is cleared; program then continues to 268 where any alarm values are stored. Program continues from 268 to 270 where a check is made to see if all supposed connected peripherals have been scanned and if not, proceeds to 260 to scan for the next peripheral. If, at program step 270, all peripherals connected to the local network have been scanned, program continues to 272 where a determination is made as to whether any unauthorized peripherals are connected to the local network and if a peripheral MAC or program CRC differs from said peripheral MAC or program CRC previously stored in the table of connected peripherals read in 258 continues to 274 where the program sends an operator a request for peripheral authentication and continues to 276. If, at 276, said operator authenticates said peripheral, program execution continues to 258 where peripherals connected to the local network are scanned again. If the operator does not authenticate the peripheral or does not have clearance to authenticate the peripheral at step 276, the program continues to 278 where an authentication error flag is set for the particular peripheral. Program then continues to 280 where it exits. If, at 272, no unauthenticated peripherals have been detected to be attached to the local network the program proceeds to 280 where it exits.

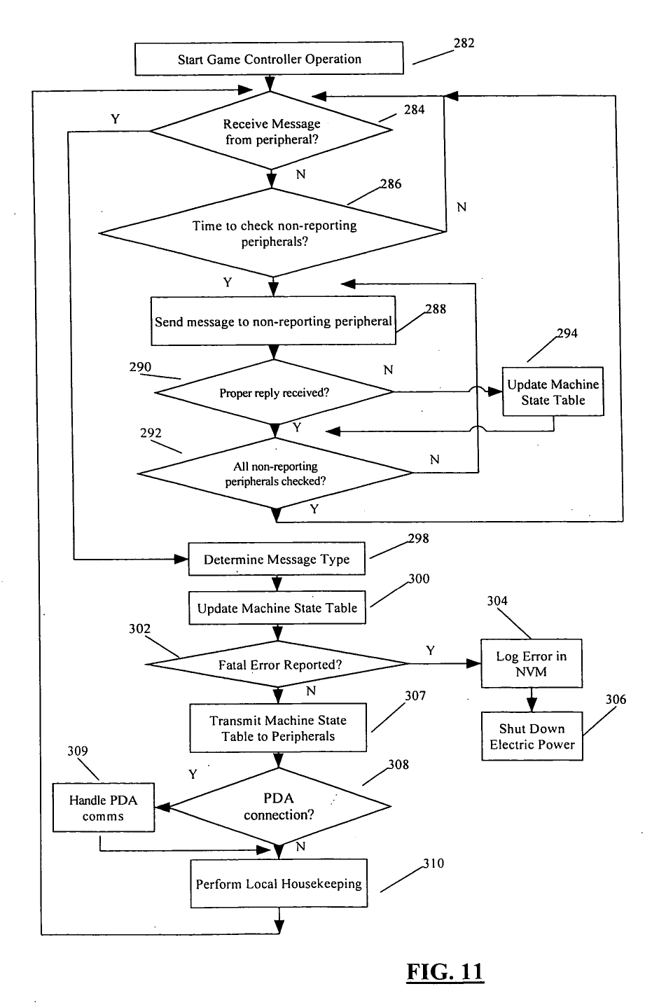

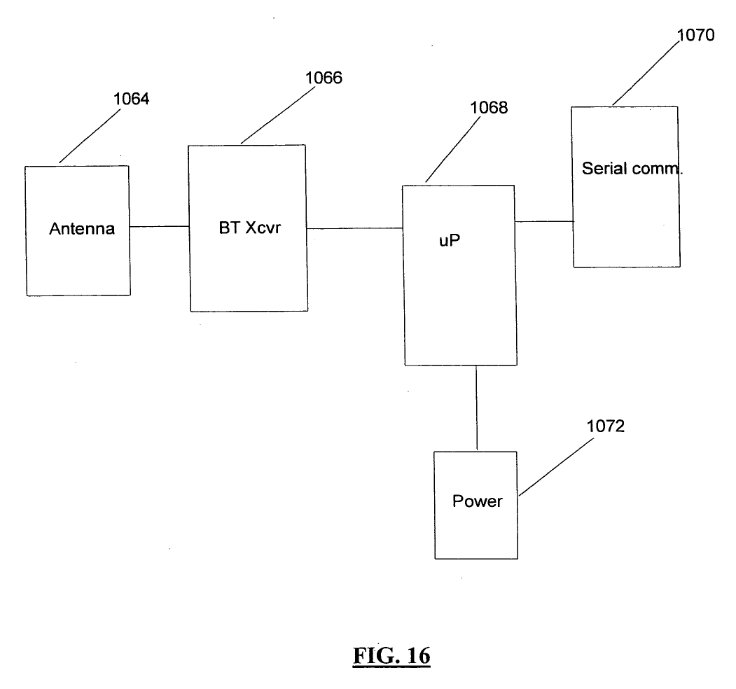

Turning now to FIG. 11 which is a flow chart representation of a main program that may run on a microcontroller in a game controller module included in a gaming machine of the present invention, said main program begins at 282 where initialization of registers and a security poll program described in FIG. 16 may be run. Authentication errors flagged by the security poll program must be cleared before the main program is allowed to continue to step 284 where a determination is made as to whether a message has been received from a peripheral connected to the local network. If no message has been received at 284, program continues to 286 where a check is made to see if a predetermined timer value indicates that any non-reporting peripherals should be queried to see if they are still operational and connected to the local network. If said predetermined time to check for non-reporting peripherals has not been reached, the program returns to 284; if it is time to check for non-reporting peripherals, the program proceeds to step 288 where a message is sent to an individual non-reporting peripheral and at 290 a determination of a predetermined proper reply from said peripheral is made. If a proper reply is not received, the program continues to 294 where an indication is made that the peripheral is not functional and program continues to 292. If the peripheral replies with a predetermined reply at 290, the peripheral is capable of operation and communication with the game controller and program continues to 292 where a determination is made as to whether all non-reporting peripherals have been scanned and, if not, returns to 288 to scan the next non-reporting peripheral.

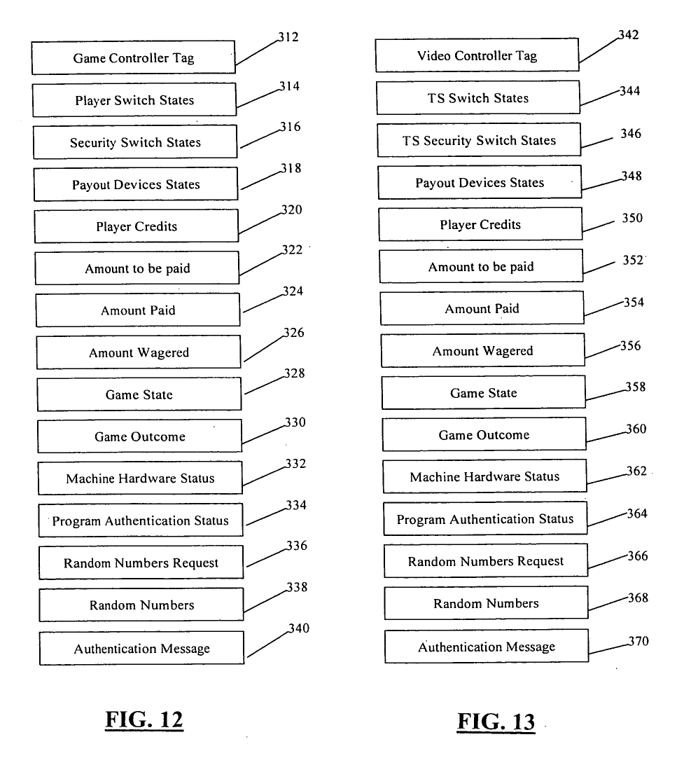

If all non-reporting peripherals have been scanned, program continues to 284 where it waits for messages from authorized peripherals connected to the local network. If, at 284, a message is received from a peripheral, program continues to 298 where a determination of message type is made after which the program continues to 300 where a machine state table that may be as represented in FIG. 12 is updated. The program continues to 302 where a determination as to whether said message reports a condition that has been predetermined to be a fatal error and if the message reports a fatal error, program continues to 304 where the date, time and fatal error is stored in nonvolatile memory after which program continues to 306 where the game controller interrupts the electric power to the gaming machine and causes it to become non-operational. If, at 302, no fatal error is reported in the received message, program continues to 307 where said machine state table is transmitted to peripherals connected to the local network and program continues to 308 where a determination is made as to whether a personal digital assistant (PDA) is attempting to contact the game controller for purpose of setup, information gathering or game change; if said PDA is not attempting to contact the game controller, the program continues to 310. If a PDA is contacting the game controller at 308, program continues to 309 where requested information is exchanged between said PDA and the game controller after which the program continues to 310 where game controller housekeeping tasks are performed after which the program continues back to 284.

In one embodiment the PDA interface is one of a broader class of interfaces that may be used with many portable devices, including game controllers, cell phones, and PDAs. An open architecture such as JAVA or HTML enabled I/O may be implemented for communication between the PDA interface and the electronic device. In one embodiment, an application specific protocol is transmitted from the gaming machine to the electronic device (e.g., cell phone) and executed on the cell phone (e.g., JAVA Virtue Machine) to program the electronic device according to the game to be played.

Turning now to FIG. 12 which is a representation of data that may be included in a machine state table that may be included in communications in a gaming machine of the present invention, 312 is a field that indicates that said machine state table originated at the game controller or at a peripheral which may affect game outcome or pay to a player. The machine state table is comprised of a plurality of fields that indicate positions of actuators, pay amounts, player wager and credits, game outcome and especially random numbers that will be used to determine outcome of a game in play. FIG. 12 is an example of a machine state table and may be comprised of the fields to be mentioned, but is not limited to said fields. Field 314 may hold a representation of the position of all player switches on a machine case; field 316 may hold a representation of the position of all security switches within a gaming apparatus; field 318 may hold a representation of states of payout devices such as coin hoppers or printers; field 320 may hold a representation of an amount of credits accrued by a player of the game; field 322 may hold a representation of an amount to be paid to a player of the game; field 324 may hold a representation of an amount paid to a player of the game; field 326 may hold a representation of an amount wagered by a player of the game; field 328 may hold a representation of a game state, which is a representation of a point in a game sequence; field 330 may hold a representation of an outcome of a game (winner or loser); field 332 may hold a representation of hardware status of a gaming apparatus upon which a game is played (this may be results of a program such as described in FIG. 16); field 334 may hold results of program authentication of program memory for each peripheral attached to the gaming controller; field 336 may hold a representation of a request by any connected peripheral for a random number generated in the game controller; field 338 may hold a representation of random numbers generated in the game controller and made available at the request of a connected peripheral; and field 340 may hold a representation of an authentication message that is used to test the integrity of the machine state table at each connected peripheral before the machine state table is used.

Turning now to FIG. 13 which is a representation of data that may be included in a machine state table that may be included in communications in a gaming machine of the present invention, 342 is a field that indicates that said machine state table originated at a non-secure peripheral that should not be allowed to affect game outcome or pay to a player. The machine state table is comprised of a plurality of fields that indicate touch screen switch actuations, representations of pay amounts, representations of player wager and credits, and representation of game outcome. Field 344 may hold a representation of switches activated by means of a player touching icons on a touchscreen overlaying a monitor attached to a video controller; field 346 may hold a representation of security switches attached to a video controller; fields 348 through 370 may be as described for fields corresponding to fields 318 through 340 in FIG. 12.

A gaming machine of the present invention is divided into two distinct categories: 1) A collection of devices that can affect game outcome, collection of player wagers and payment of awards due to a player that is controlled by peripherals reporting to a game controller which is running a program that is not alterable by said game controller and is easily validated in the field by gaming enforcement authorities using simple equipment.

2) A collection of peripherals that cannot affect game outcome, collection of player wagers and payment of awards due to a player that is controlled by the game controller. An example of aforesaid may be, but is not limited to, a video display running on a personal computer (PC) based controller that requests all information that affects game outcome and player awards from the game controller and that only acts as a display device. Many commonly available operating systems running upon a PC actually run in random access memory (RAM) and alter contents of program memory as they run unless special modifications are made to said operating systems. If contents of program memory are altered in operation, it becomes very difficult to verify that program memory has not been altered to affect a program in such a way that critical aspects (game outcome and award) of a game are preserved when the program is run again.

Operation of a gaming machine of the present invention is much like standard older non-PC based gaming machines. Any switches on a gaming machine front panel actuated by a player during game play are reported to the game controller from a peripheral door controller mounted in proximity to the point of monitor and control by means of said door controller modifying a machine state table an example of which is shown in FIG. 12. The game controller receives said machine state table and acts upon fields in the machine state table according to a predetermined program running on a microprocessor. The machine state table may be altered according to said predetermined program and transmitted to peripherals connected to the game controller. By means of the aforesaid, a player can play a game. The program running on said microprocessor controlling the game controller performs all game outcome determination, which is generally accomplished by means of pseudo-random numbers. No decision affecting game outcome, acceptance of wager or payment of award is made by any peripheral. Said decisions are made by the program running on the microprocessor on the game controller and transmitted to peripherals controlling pay and play of the game. Peripherals can only report status of external devices and act upon commands transmitted to the peripherals from the game controller. There is one instance in which a peripheral may act independently of the game controller and that is when said peripheral receives a memory signature or MAC identification from any other peripheral or game controller that does not correspond to a pre-authorized value. In said instance, the peripheral may disable all outputs and inputs that are controlled by the peripheral except for the communication bus connecting the game controller and peripherals. The peripheral then waits for a predetermined startup command originating at the game controller to be received before normal operation continues.

A non-secure peripheral such as a PC based video controller operating a video monitor overlaid by a touch screen reports all player actions required to play a game and requests each game state that determines game outcome from the game controller by means of a machine state table such as shown in FIG. 13. Each time a random number is required to advance to a game state, said video controller requests said random number value from the game controller and waits until the random number value is received before continuing. Alternatively, the video controller may be sent all game determining values and awards for one game by the game controller upon receiving an indication that a player desires to play a game.

The effect of the aforesaid is that a program that is unalterable by a microprocessor running said program has complete control over all game outcome, acceptance of player wager and award to a player. The program is validated by signature means.

Some games are currently being manufactured that operate by means of a network connection to a central server. Gaming apparatus for player interface can be reduced to what is commonly known as a thin client,into which an entire program can be downloaded by said server and caused to operate by commands from the server in response to player actions. An unscrupulous person can modify said program downloaded to said thin client and cause undesirable behavior of the gaming apparatus resulting in a player or operator being cheated. The present invention may act to secure a thin client by requiring that an encrypted communication be transmitted within a predetermined time interval from a pc based device acting as a communication point to the game controller. A public key encryption algorithm may be employed at the game controller and at said communication point. An operator may enter a key by means of a PDA communicating with the game controller to authorize operation. If a game controller or communication point is disabled, substituted or reprogrammed, the thin client will be disabled. Alternatively, the game controller can become a communication point and all program data passed to a PC type device that operates a game must pass through the game controller and be installed upon the PC type device. The game controller may require predetermined authorization sequences from the central server prior to allowing downloaded code to be installed upon the PC type device.

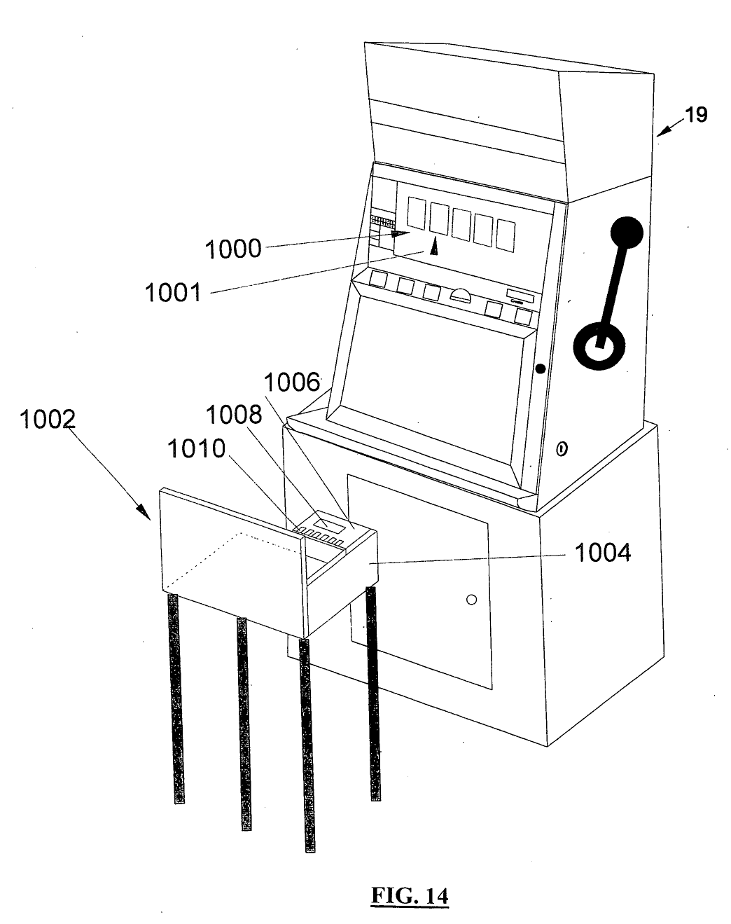

Turning now to FIG. 14, which is a representation of a gaming apparatus 19 and a chair 1002 incorporating features for player comfort in playing said gaming apparatus, a game 1000 is presented to a player that he desires to play. Generally a player would play said game by interacting with the gaming apparatus by means of switches or a touchscreen while seated upon a chair 1002. In the illustration a player may choose a comfortable position and interact with the gaming apparatus by means of an interface 1006 that folds out from the chair and which includes buttons 1010 and a touch pad 1008. A means of allowing player selection may be by means of a cursor 1001 on the main display of the gaming apparatus, said cursor being controlled by the player by means of movements upon touchpad 1008. Additional means of interacting with a game may be provided by means of switches 1010. Communication between the player and the gaming machine may be by means of a wireless link that is supported by means of an electronic interface in the player chair and an electronic interface installed in the gaming apparatus.

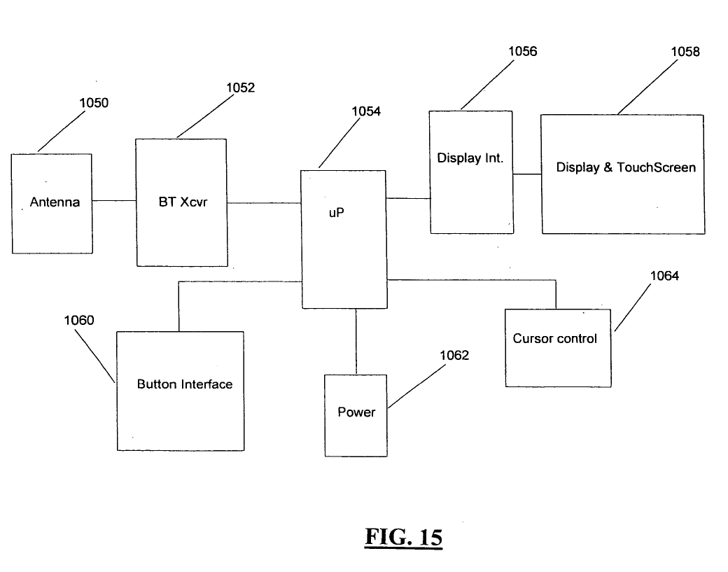

Turning now to FIG. 15, which is a block diagram representation of an electronic interface that may be installed in a player chair; block 1054 represents a microcontroller that may control the interface. A control switch interface to allow a player control of aspects of the game is represented by 1060 and a display and touchscreen interface is represented by 1056, said touchscreen interface connects to a display and touchscreen represented by 1058. A separate player cursor input may be provided to the microcontroller at 1064. User control of a game is communicated to the microcontroller that communicates representation of said control to an electronic interface in the gaming apparatus by means of a wireless transceiver 1052 and antenna 1050. Electrical power is provided by means of a power supply 1062.

Turning now to FIG. 16, which is a block diagram representation of an electronic interface that may be installed in a gaming apparatus to communicate with a communication interface in a player chair; wireless communication of player actions that are communicated to the gaming apparatus by the electronic interface described in FIG. 15 are received by antenna 1064 and transceiver 1066 and communicated to microcontroller 1068 for data processing. After data in the communication signal is processed by said microcontroller a representation of player actions at the player chair is communicated to the gaming apparatus by means of serial communications circuitry 1070. Electrical power is provided by means of power supply 1072.

Player chair interface may be constructed of readily available components in which antenna 1050 may be a chip antenna of model number FR05-S1-N-0-001 manufactured by Fractus, wireless transceiver 1052 may be a Bluetooth transceiver of model number LMX9820A manufactured by National Semiconductor, microcontroller 1054 may be an ATMegal62 manufactured by Atmel Corporation, cursor controller 1064 may be a GlidePoint touch pad manufactured by Alps Electric, button interface 1060 may be a set of commonly available momentary switches and power supply 1062 may be constructed a commonly available switching converter chip manufactured by Micrel and powered by PC-10 ultracaps available from Maxwell Technology or by primary cell batteries.

Gaming machine interface may be constructed of the same components used in the player chair interface and which correspond to the blocks therein except for the power supply 1072 which may be constructed of a converter chip manufactured by Micrel and a serial communications converter 1070 may be of a type MAX232 manufactured by Maxim.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing RF communications (e.g., 2.4 GHz), any other frequency or any of the known or to be developed protocols may be considered equivalent and considered as if set forth herein, and any other device having an equivalent function or capability, whether or not listed herein, may be substituted therewith. Such substitutions for the described parts do not depart from the scope of the present invention. All other described items, including, but not limited to busses, quick connects, RF enclosures, shielding, portable devices, user interfaces, memory protection circuitry, signatures, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art. For example, any of the devices enumerated here can be described as a series of steps to implement the described gaming machine or any component thereof. Any such steps can be embodied as a computer readable code that, when loaded into a computer, cause the computer to perform the steps of the method(s).

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW±, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, communicating between components of a gaming machine or a component of the gaming machine and a controller of the gaming machine (such communications may be of any protocol, e.g., 802.11 series communications protected by one or more encryption schemes), user interfaces and the provision of appropriate instructions to portable devices to interact as required for playing a game on the gaming machine, checking computer memories and verifying memory contents, and the display, storage, or communication of results according to the processes of the present invention.

The present invention may suitably comprise, consist of, or consist essentially of, any of element or features of the invention, and their equivalents as described herein. Further, the present invention illustratively disclosed herein may be practiced in the absence of any element, whether or not specifically disclosed herein. Numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A gaming machine, comprising:
a gaming machine enclosure;
a series of gaming components operable together to enable the gaming machine to play a game;
wherein a least two of the gaming machine components communicate with each other via High Frequency (HF) communications.

2. The gaming machine according to claim 1, wherein the gaming machine plays a game of chance.

3. The gaming machine according to claim 1, wherein the gaming machine accepts wagers and plays a game of chance.

4. The gaming machine according to claim 1, wherein the gaming machine plays a skill game whose outcome is substantially determined by a player's skill.

5. The gaming machine according to claim 1, wherein the HF communications comprise wireless Radio Frequency (RF) communications and the gaming machine enclosure is an RF shielded enclosure that prevents RF leakage of the wireless communications.

6. The gaming machine according to claim 1, wherein the enclosure provides one lead in a power distribution system configured to distribute power to the gaming components.

7. The gaming machine according to claim 6, wherein the HF communications are carried over the power distribution system.

8. The gaming machine according to claim 1, further comprising a power bus configured to distribute a power lead to the gaming components.

9. The gaming machine according to claim 8, wherein the power bus comprises a quick connect power bus.

10. The gaming machine according to claim 8, wherein the enclosure comprises a return power ground for the gaming components.

11. The gaming machine according to claim 1, wherein the gaming machine comprises a main board and peripheral controllers and all action s affecting game outcome are performed on the main board and all memory subject to gaming regulation checking is only accessible on the main board.

12. The gaming machine according to claim 1, wherein the series of gaming components includes a video controller and screen for displaying at least a part of a game to be played on the gaming machine, wherein the video controller makes no decisions regarding game outcome.

13. A gaming machine, comprising:
a gaming machine enclosure;
a series of gaming components operable together to enable the gaming machine to play a game; and
a main processing board comprising a game machine control processor and memory for storing programming for the game machine control processor comprising at least one game to be played by the gaming machine;
wherein:
the gaming components in communication with the main processing board are coupled via at least one serial link such that all game outcome determinations of the main processing board are separated from the gaming components by at least a serial interface.

14. The gaming machine according to claim 13, wherein at least one of the gaming machine components communicate via RF wireless communications.

15. The gaming machine according to claim 13, further comprising a memory protection device configured to prevent tampering with the memory.

16. The gaming machine according to claim 15, wherein the game outcome determinations are determined only by programming contained in the memory on the main processing board and protected by the memory protection device.

17. A gaming machine device, comprising:
a gaming machine enclosure comprising a user interface including a display for showing results of a game played on the gaming machine and user input devices on the enclosure and accessible to a gaming machine user;
a second user interface device separate and apart from the gaming machine and gaming machine enclosure and a wireless communication mechanism that transmits user inputs from the second user interface; and
a wireless receiver coupled to the gaming machine and configured to receive user inputs transmitted from the second user interface;
wherein the gaming machine is operable from the user input devices on the enclosure and/or the second user interface. device.

18. The gaming machine according to claim 17, wherein the second user input device is secured to a chair.

19. The gaming machine according to claim 17, wherein the second user input device is movable affixed to a chair in a manner that it can be placed in an adjustable position on the chair.

20. The gaming machine according to claim 17, wherein the second user input device is coupled via the wireless link via a serial communication.

21. The gaming machine according to claim 18, wherein the second user interface folds out from a hidden position in the chair.

22. The gaming device according to claim 17, wherein the second user input device comprises a portable electronic device.
